(19) United States
(12) Patent Application Publication
(10) Pub. No.: US 2025/0115387 A1
(43) Pub. Date: Apr. 10, 2025

(54) LABEL PRINTER

(71) Applicant: TOSHIBA TEC KABUSHIKI KAISHA, Tokyo (JP)

(72) Inventor: Tsuyoshi Sanada, Susono Shizuoka (JP)

(21) Appl. No.: 18/987,201

(22) Filed: Dec. 19, 2024

Related U.S. Application Data
(62) Division of application No. 17/685,419, filed on Mar. 3, 2022.

(30) Foreign Application Priority Data
Jun. 23, 2021 (JP) 2021-104037

(51) Int. Cl. B65C 9/18; B41J 3/407; B65C 9/26

(52) U.S. Cl. CPC B65C 9/1869; B41J 3/4075; B65C 9/26

(57) ABSTRACT

A top cover moves between a first position where the top cover is opened with respect to a lower cover and a second position where the top cover is closed with respect to the lower cover. A label peel-off unit moves between a third position where the label peel-off unit is opened with respect to the lower cover and a fourth position where the label peel-off unit is closed with respect to the lower cover. A lock portion engages with an operable engagement claw provided on the top cover and an engagement claw housed in the lower cover to prevent the top cover from moving from the second position. A protruding portion protrudes upstream in a label conveying direction, abuts against the engagement claw, and causes the label peel-off unit to move from the fourth position to the third position by the engagement claw.

### CROSS-REFERENCE TO RELATED APPLICATIONS

This application is a Divisional of application Ser. No. 17/685,419 filed on Mar. 3, 2022, the entire contents of which are incorporated herein by reference.

This application is based upon and claims the benefit of priority from Japanese Patent Application No. 2021-104037, filed on Jun. 23, 2021, the entire contents of which are incorporated herein by reference.

### FIELD

Embodiments described herein relate generally to a label printer.

### BACKGROUND

In the related art, a label printer is known that prints information on a print surface of a label of a label continuous body wound in a roll shape, peels the printed label from a liner, and dispenses the peeled label.

In such a label printer, when the printed label is dispensed in a peeled state, a label peel-off unit that pulls the label to bend the liner is provided in a state of being openable and closable on a part of a front cover of the label printer.

In order to appropriately peel the label from the liner in such a label printer, a label printer is present in which a top cover that presses the label during printing and the label peel-off unit that pulls the label to peel the label from the liner are required to be opened and closed in an appropriate order.

In the label printer, if a printing operation is executed while a closing procedure that is not appropriate is executed, the label may not be appropriately peeled and conveyance failure may be caused.

### DESCRIPTION OF THE DRAWINGS

FIG. 1 is a perspective view illustrating a label printer according to a first embodiment;

FIG. 2 is a perspective view illustrating a state in which a label continuous body is housed;

FIG. 3 is a perspective view illustrating a state in which a top cover is opened;

FIG. 4 is an enlarged view of a front end portion in a state in which both the top cover and a label peel-off unit are opened;

FIG. 5 is an enlarged view of the front end portion in a state in which the label printer is closed;

FIG. 6 is an enlarged view of the front end portion in a state in which an operation lever is slightly operated from a closed state;

FIG. 7 is an enlarged view of the front end portion in a state in which the operation lever is further operated from the state in FIG. 6;

FIG. 8 is an enlarged view of a front end portion in a state in which a label printer according to a second embodiment is closed; and

FIG. 9 is an enlarged view of the front end portion of the label printer to be closed according to an erroneous closing procedure.

### DETAILED DESCRIPTION

In general, according to one embodiment, a label printer is provided. The label printer reduces, even if an erroneous closing procedure is executed, occurrence of conveyance failure caused by not appropriately peeling a label.

The label printer according to the present embodiment includes a lower cover, a top cover, a label peel-off unit, an engagement claw, a lock portion, and a protruding portion. The lower cover is a rectangular parallelepiped case in which a part of a front surface and an upper surface are open, and protects a printer main body. The top cover moves between a first position where the top cover is opened with respect to the lower cover and a second position where the top cover is closed with respect to the lower cover. The label peel-off unit is located downstream of the lower cover in a label conveying direction and moves between a third position where the label peel-off unit is opened with respect to the lower cover and a fourth position where the label peel-off unit is closed with respect to the lower cover. The lock portion engages with an operable engagement claw provided on the top cover and the engagement claw housed in the lower cover to prevent the top cover from moving from the second position. The protruding portion is a part of an exterior member of the label peel-off unit, protrudes upstream in the label conveying direction, abuts against the engagement claw, and causes the label peel-off unit to move from the fourth position to the third position by the engagement claw.

Hereinafter, the label printer according to the present embodiment will be described with reference to the drawings.

### First Embodiment

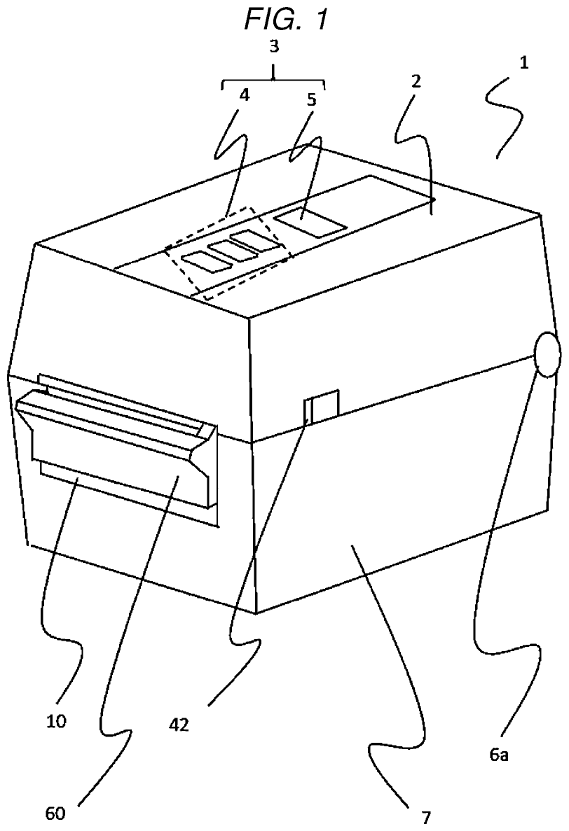

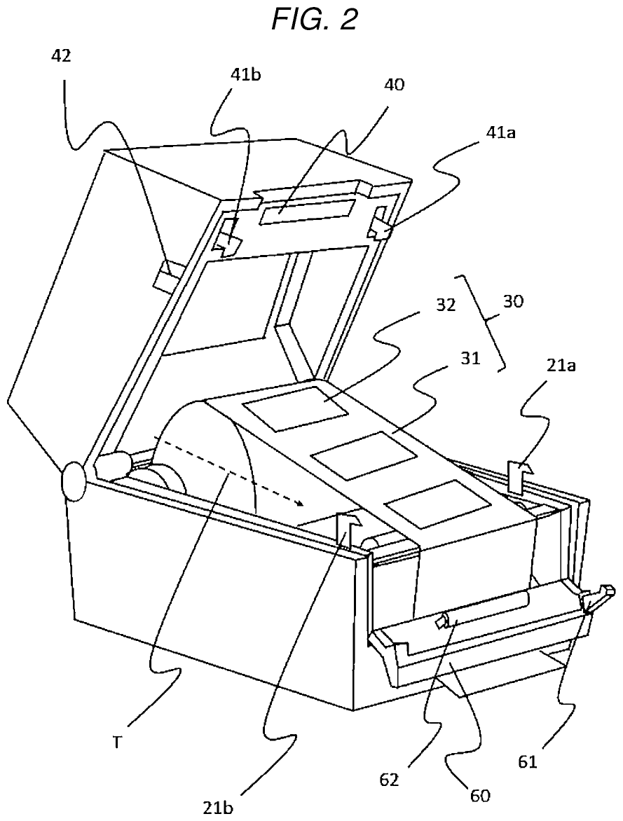

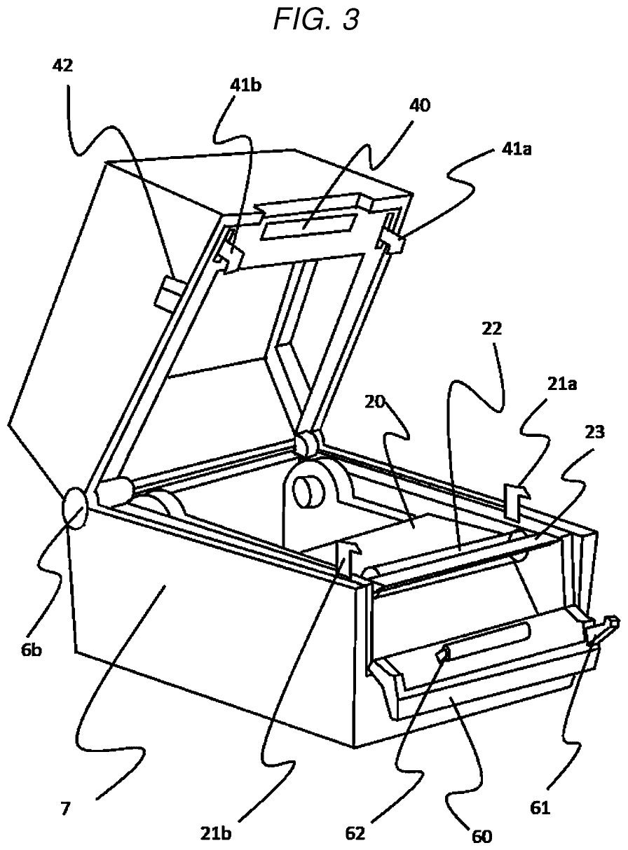

FIG. 1 is a perspective view illustrating a label printer according to a first embodiment. FIG. 2 is a perspective view illustrating a state in which a label continuous body is housed in the label printer according to the first embodiment; and FIG. 3 is a perspective view illustrating a state in which a top cover of the label printer according to the first embodiment is opened.

As shown in FIGS. 1 to 3, a label printer 1 according to the first embodiment mainly includes: a printer main body 20; a lower cover 7 that stores the printer main body 20; a top cover 2 that is rotatable and supported with respect to the printer main body 20 by a rotation support unit 6a and a rotation support unit 6b and covers an upper portion of the printer main body 20; and a label peel-off unit 60 that is rotatable and supported with respect to the printer main body 20 by a rotation support unit (not illustrated) and covers a front surface of the printer main body 20. The printer main body 20 mainly includes a lock portion 21, a platen roller 22, a peeling bar 23, a thermal head 40, and an engagement claw 41. The printer main body 20 is housed inside a space defined by the top cover 2, the lower cover 7, and the label peel-off unit 60. When the printer main body 20 is stored in the space defined by the top cover 2, the lower cover 7, and the label peel-off unit 60, a space is formed between the printer main body 20 and the label peel-off unit 60 that is in a closed state, and this space is in open communication with a sheet discharge port 10. The printer main body 20 executes the printing on labels 32 using the thermal head 40.

Inside the printer main body 20, a storage unit is provided on a rear end side of the printer main body 20. The storage unit stores a label continuous body 30 that includes a liner 31 and the labels 32 detachably attached to the liner. The label continuous body 30 is conveyed in a direction (hereinafter, referred to as a label conveying direction) of a broken line arrow T illustrated in FIG. 2. The platen roller 22 and the peeling bar 23 are provided on a leading end side of the printer main body 20. The platen roller 22 is connected to a drive motor as a drive source (not illustrated) via a gear or the like. The peeling bar 23 peels the label 32 from the liner 31 by bending the liner 31. The smaller an angle at which the liner 31 is bent by the peeling bar 23, the more easily the label 32 is peeled from the liner 31. In a leading end portion of the printer main body 20, a lock portion 21a and a lock portion 21b are provided on the space formed between the printer main body 20 and the label peel-off unit 60 that is in the closed state and an upper surface of the printer main body 20.

The lower cover 7 is a rectangular parallelepiped case in which an upper surface and a part of a front surface are open. The lower cover 7 protects the printer main body 20 inside the lower cover 7 by covering the upper surface by the top cover 2 and closing the label peel-off unit 60 on the front surface. The lower cover 7 is provided with a connection terminal (not illustrated) that supplies power to the printer main body 20 inside the lower cover 7.

The top cover 2 is capable of moving between an opened state (hereinafter, referred to as a first position) in which the label continuous body 30 is capable of being stored in the printer main body 20 and a closed state (hereinafter, referred to as a second position) in which printing is capable of being executed on the label 32. The top cover 2 is provided with a control panel 3 including an operation button 4 and a display unit 5. An operator is capable of executing various operations using the operation button 4 and is capable of checking various types of information on the display unit 5.

The top cover 2 houses, in the printer main body 20, the thermal head 40, the engagement claw 41, and an operation lever 42. The thermal head 40 prints by sandwiching the label continuous body 30 between the thermal head 40 and the platen roller 22. The platen roller 22 includes a rotation shaft and is rotatable in a sheet conveying direction. The engagement claw 41 maintains a closed state of the label printer 1 by engaging with the lock portion 21a and the lock portion 21b. An engagement claw 41a and an engagement claw 41b are connected to the operation lever 42, and move in the label conveying direction in conjunction with an operation of the operation lever 42. That is, the engagement claw 41 is capable of moving between a position at which the engagement claw 41 engages with the lock portion 21 and a position at which the engagement claw 41 is separated from the lock portion 21. The engagement claw 41 is connected to a spring (not illustrated) and is urged in a direction opposite to the label conveying direction.

The label peel-off unit 60 moves between a position (hereinafter, referred to as a third position) where the label peel-off unit 60 is opened for inserting the liner 31 into the sheet discharge port 10 and a position (hereinafter, referred to as a fourth position) where a nip roller 62 of the label peel-off unit 60 abuts against the platen roller 22 and the label peel-off unit 60 is closed for sandwiching the liner 31 therebetween. The label peel-off unit 60 includes the nip roller 62. When the label peel-off unit 60 is located at the fourth position, the nip roller 62 abuts against the platen roller 22, thereby assisting the peeling of the label 32 from the liner 31 and the conveyance of the liner 31, on which the peeling is completed, to the sheet discharge port 10. An exterior member, of the label peel-off unit 60, facing the printer main body 20 includes a protruding portion 61 that enters the inside of the top cover 2 when the label peel-off unit 60 is located at the fourth position.

The protruding portion 61 abuts against the engagement claw 41a when the engagement claw 41a is located downstream in the label conveying direction. The protruding unit 61 is pushed out by the engagement claw 41 when the engagement claw 41 is separated from the lock portion 21. That is, the label peel-off unit 60 is pushed out from the fourth position toward the third position by the protruding portion 61 being pushed out by the engagement claw 41. The protruding portion 61 may be formed integrally with the label peel-off unit 60 or may be another member. The present embodiment describes that the protruding unit 61 is provided at an end portion of the label peel-off unit 60 on an engagement claw 41a side, but the protruding portion 61 may be provided at either end portion of the label peel-off unit 60 in a direction perpendicular to the label conveying direction or may be provided at both ends.

The nip roller 62 is rotatable and provided on the label peel-off unit 60, and is a driven roller that does not include the drive source. In a state in which the nip roller 62 is located at the fourth position, by pressing the liner 31 from a side located downstream in the label conveying direction as viewed from the peeling bar 23, the liner 31 is bent to an angle necessary for peeling the label 32 from the liner 31 by the peeling bar 23 while abutting against the peeling bar 23.

A gap is formed between an upper end portion of the label peel-off unit 60 and a lower portion of a leading end of the top cover 2. A label discharge port 8 from which the printed label 32 is discharged is formed at this gap.

The sheet discharge port 10 is formed at a lower portion of the label peel-off unit 60, and the liner 31 from which the label 32 is peeled by the peeling bar 23 is discharged from the sheet discharge port 10.

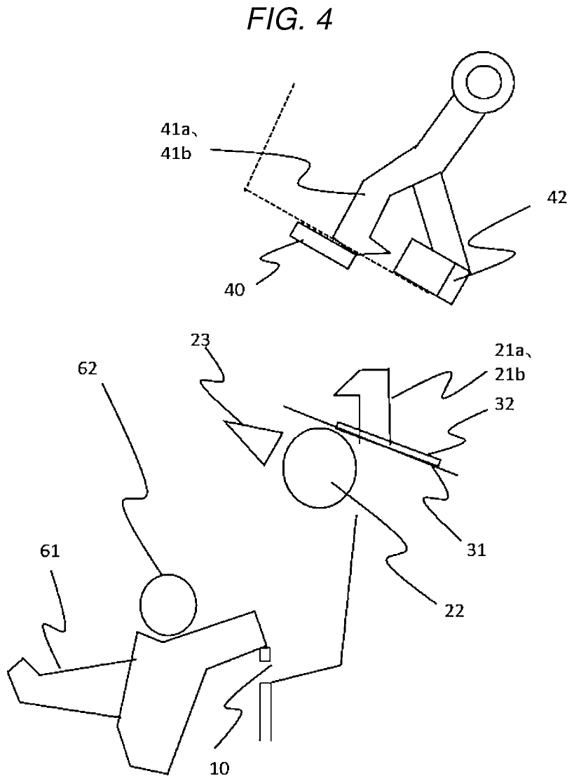

Next, operations of the engagement claw 41 and the label peel-off unit 60 will be described with reference to FIGS. 4 to 7.

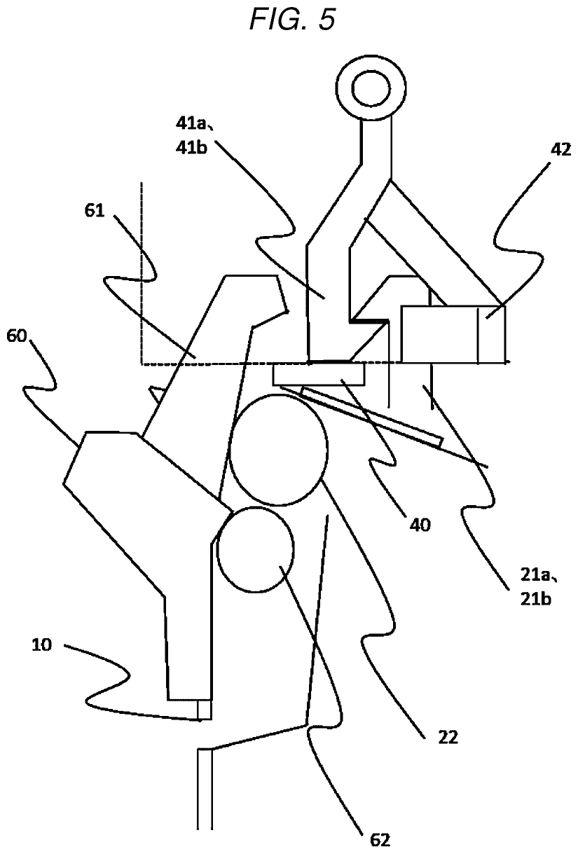

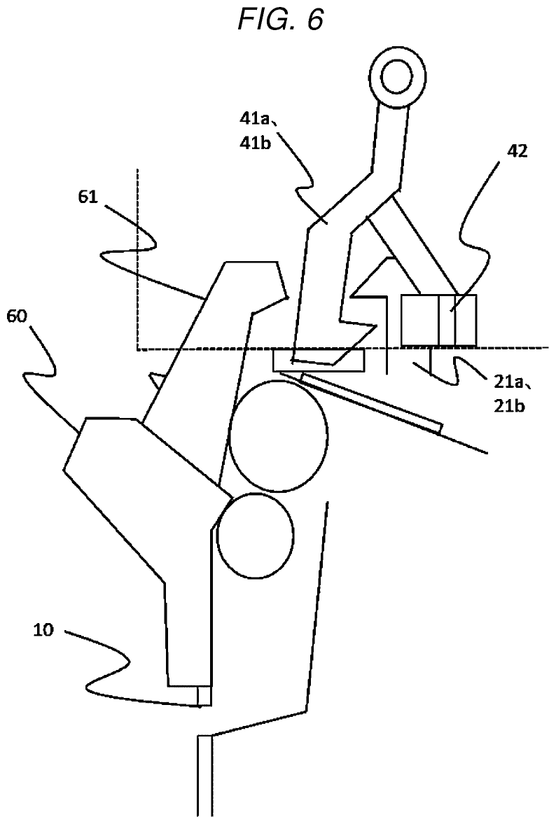

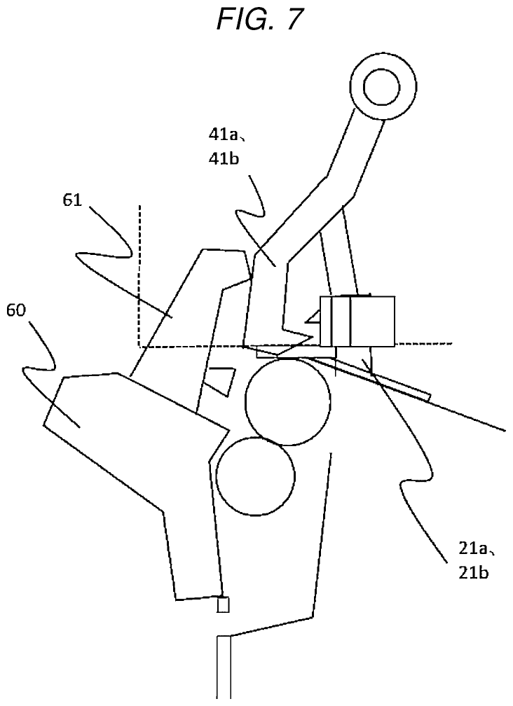

FIG. 4 is an enlarged view of a front end portion of the label printer 1 according to the first embodiment in a state in which both the top cover 2 and the label peel-off unit 60 are opened. FIG. 5 is an enlarged view of the front end portion in a state in which the label printer 1 according to the first embodiment is closed. FIG. 6 is an enlarged view of the front end portion in a state in which the operation lever 42 is slightly operated from the closed state. FIG. 7 is an enlarged view of the front end portion in a state in which the operation lever 42 is further operated from the state in FIG. 6.

When the printing is executed on the label 32, the operator inserts the liner 31 into the sheet discharge port 10 in a state in which the top cover 2 and the label peel-off unit 60 are opened as illustrated in FIG. 4. In order to execute the printing by the label printer 1, the top cover 2 is moved to the second position that is a closed position of the top cover 2, and the label peel-off unit 60 is moved to the fourth position that is a closed position of the label peel-off unit 60.

At this time, in order to maintain the label 32 at an appropriate print position, the top cover 2 is first moved to the second position. Thereafter, the label peel-off unit 60 is moved to the fourth position. When the operator moves the top cover 2 from the first position to the second position, the operator operates the operation lever 42 and moves the engagement claw 41 toward a label conveying direction side to cause the engagement claw 41 to engage with the lock portion 21. After the top cover 2 is moved to the second position, the operator stops the operation for the operation lever 42, so that the engagement claw 41 moves to a position where the engagement claw 41 engages with the lock portion 21 by an urging force upstream in the label conveying direction applied by the attached spring.

By closing the top cover 2 and the label peel-off unit 60 in the above procedure, the label printer is in the closed state as illustrated in FIG. 5.

Next, a procedure of switching the label printer from the closed state as illustrated in FIG. 5 to the opened state as illustrated in FIG. 4 will be described.

First, since the top cover 2 and the label peel-off unit 60 are in the closed state, the operator operates the operation lever 42 and moves the engagement claw 41 in the label conveying direction to release the state in which the engagement claw 41 engages with the lock portion 21 (see FIG. 6). When the operator moves the top cover 2 to the first position while operating the operation lever 42, the engagement claw 41a abuts against the protruding portion 61 (see FIG. 7).

Since the top cover 2 is lifted from the state in which the engagement claw 41a abuts against the protruding portion 61 as illustrated in FIG. 7, the protruding portion 61 is pushed out by applying a force toward the label conveying direction side. That is, the label peel-off unit 60 moves from the fourth position to the third position by being pushed out by the engagement claw 41a via the protruding portion 61.

### Second Embodiment

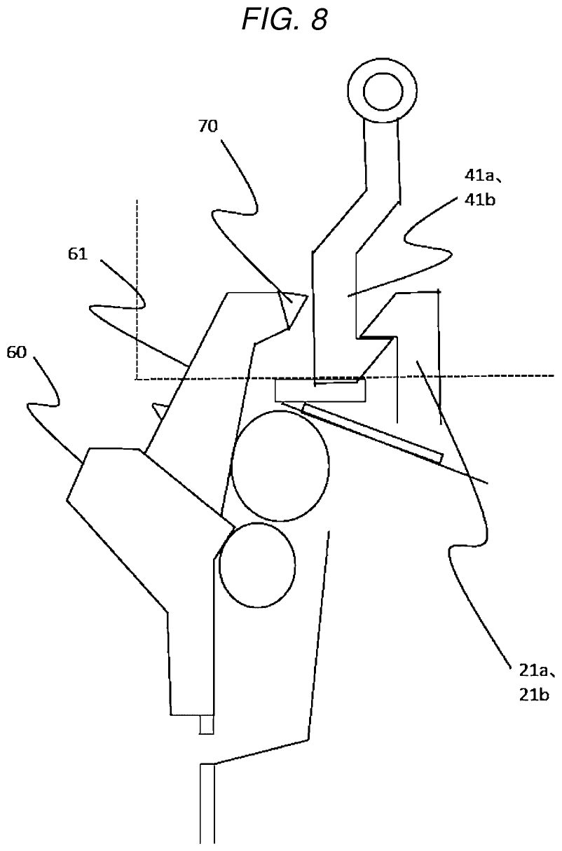

FIG. 8 is an enlarged view of a front end portion in a state in which a label printer according to a second embodiment is closed. A configuration according to the second embodiment is different from a configuration according to the first embodiment in that an interference member 70 that interferes with the engagement claw 41 is provided at an end portion of the protruding portion 61.

In this configuration, the interference member 70 is provided at an end portion of the protruding portion 61. The end portion is not connected to the label peel-off unit 60. The interference member 70 may be different from the protruding portion 61 or may be integrally molded. Also in such a configuration, the label peel-off unit 60 is capable of moving from the fourth position to the third position by being pushed out by the engagement claw 41 via the protruding portion 61 when the top cover 2 is opened. In the second embodiment, an erroneous closing procedure is capable of being prevented.

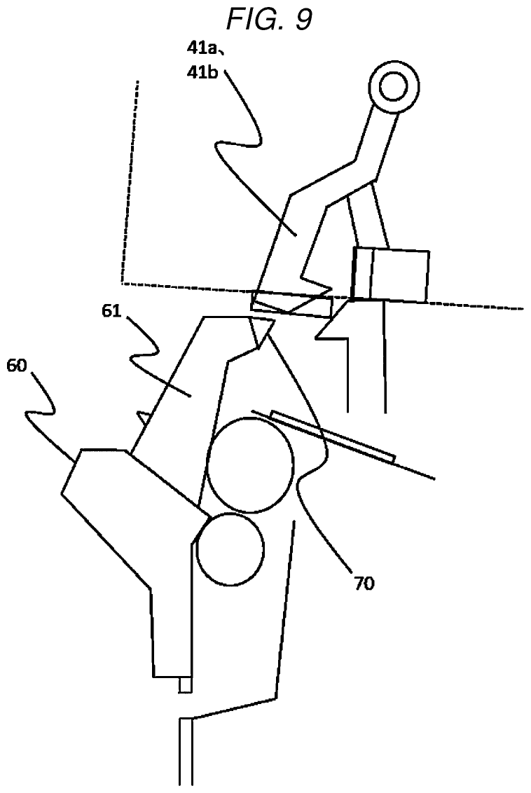

FIG. 9 is an enlarged view of the front end portion of the label printer to be closed according to the erroneous closing procedure in the second embodiment. That is, FIG. 9 illustrates a state in which the label peel-off unit 60 is moved to the fourth position before the top cover 2 is moved to the second position. In such a case, if the top cover 2 is moved from the first position to the second position, the interference member 70 abuts against the engagement claw 41a.

Since the interference member 70 interferes with the engagement claw 41a, the engagement claw 41 is not capable of engaging with the lock unit 21, and the top cover 2 does not become in the closed state.

According to at least one of the embodiments described above, even if an erroneous opening and closing procedure is executed, conveyance failure caused by not appropriately peeling the label is reduced. The disclosure is not limited to the above embodiments, and various modifications are capable of being made. In the first embodiment and the second embodiment, for example, a rotatable roller may be fitted to a leading end of the protruding portion 61 or the interference member 70. The lock portion 21 may be operated instead of operating the engagement claw 41. If the lock portion 21 is operated, the operation lever 42 may be provided with the lower cover 7.

The embodiments of the disclosure are described, but the embodiments are presented as examples and are not intended to limit the scope of the disclosure. These novel embodiments are capable of being implemented in various forms, and various omissions, substitutions, and modifications may be made without departing from the scope of the disclosure. The embodiments and the modification thereof are included in the scope and the spirit of the disclosure and are also included in the disclosure described in the scope of claims and an equivalent scope thereof.

What is claimed is:

1. A label printer, comprising:
a lower cover;
a top cover movable between a first position where the top cover is opened with respect to the lower cover and a second position where the top cover is closed with respect to the lower cover;
a label peel-off component that is located downstream in a label conveying direction with respect to the lower cover and movable between a third position where the label peel-off component is opened with respect to the lower cover and a fourth position where the label peel-off component is closed with respect to the lower cover;
an engagement claw provided in the top cover;
a lock portion that engages with the engagement claw housed in the lower cover;
a protruding portion that is a part of an exterior member of the label peel-off component, that protrudes upstream in the label conveying direction, that abuts against the engagement claw, and that causes the label peel-off component to move from the fourth position to the third position by the engagement claw; and
at an end portion of the protruding portion that abuts against the engagement claw, an interference member that interferes with the engagement claw when the top cover moves from the first position to the second position.

2. The label printer according to claim 1, further comprising:
a rotation member that is rotatable at an end portion of the interference member that abuts against the engagement claw.

3. The label printer according to claim 2, wherein the rotation member is a rotatable roller.

4. The label printer according to claim 1, wherein
the engagement claw is located outside a width-direction edge of a label sheet, and
the protruding portion is further located outside the width-direction edge of a label sheet.

5. The label printer according to claim 1, wherein
the protruding portion is provided at each of both end portions of the label peel-off unit in a direction perpendicular to the label conveying direction.

6. The label printer according to claim 1, further comprising:
a printer main body comprising a storage compartment that stores a label continuous body that includes a liner and labels detachably attached to the liner.

7. The label printer according to claim 1, further comprising:
a printing head.

8. A thermal label printer, comprising:
a lower cover;
a top cover movable between a first position where the top cover is opened with respect to the lower cover and a second position where the top cover is closed with respect to the lower cover;
a label peel-off component that is located downstream in a label conveying direction with respect to the lower cover and movable between a third position where the label peel-off component is opened with respect to the lower cover and a fourth position where the label peel-off component is closed with respect to the lower cover;
an engagement claw provided in the top cover;
a lock portion that engages with the engagement claw housed in the lower cover;
a protruding portion that is a part of an exterior member of the label peel-off component, that protrudes upstream in the label conveying direction, that abuts against the engagement claw, and that causes the label peel-off component to move from the fourth position to the third position by the engagement claw; and
at an end portion of the protruding portion that abuts against the engagement claw, an interference member that interferes with the engagement claw when the top cover moves from the first position to the second position.

9. The thermal label printer according to claim 8, further comprising:
a rotation member that is rotatable at an end portion of the interference member that abuts against the engagement claw.

10. The thermal label printer according to claim 9, wherein the rotation member is a rotatable roller.

11. The thermal label printer according to claim 8, wherein
the engagement claw is located outside a width-direction edge of a label sheet, and
the protruding portion is further located outside the width-direction edge of a label sheet.

12. The thermal label printer according to claim 8, wherein
the protruding portion is provided at each of both end portions of the label peel-off unit in a direction perpendicular to the label conveying direction.

13. The thermal label printer according to claim 8, further comprising:
a printer main body comprising a storage compartment that stores a label continuous body that includes a liner and labels detachably attached to the liner.

14. The thermal label printer according to claim 8, further comprising:
a thermal printing head.

15. A portable label printer, comprising:
a lower cover;
a top cover movable between a first position where the top cover is opened with respect to the lower cover and a second position where the top cover is closed with respect to the lower cover;
a label peel-off component that is located downstream in a label conveying direction with respect to the lower cover and movable between a third position where the label peel-off component is opened with respect to the lower cover and a fourth position where the label peel-off component is closed with respect to the lower cover;
an engagement claw provided in the top cover;
a lock portion that engages with the engagement claw housed in the lower cover; and
a protruding portion that is a part of an exterior member of the label peel-off component, that protrudes upstream in the label conveying direction, that abuts against the engagement claw, and that causes the label peel-off component to move from the fourth position to the third position by the engagement claw; and
at an end portion of the protruding portion that abuts against the engagement claw, an interference member that interferes with the engagement claw when the top cover moves from the first position to the second position.

16. The portable label printer according to claim 15, further comprising:
a rotation member that is rotatable at an end portion of the interference member that abuts against the engagement claw.

17. The portable label printer according to claim 16, wherein
the rotation member is a rotatable roller.

18. The portable label printer according to claim 15, wherein
the engagement claw is located outside a width-direction edge of a label sheet, and
the protruding portion is further located outside the width-direction edge of a label sheet.

19. The portable label printer according to claim 15, wherein
the protruding portion is provided at each of both end portions of the label peel-off unit in a direction perpendicular to the label conveying direction.

20. The portable label printer according to claim 15, further comprising:
a printer main body comprising a storage compartment that stores a label continuous body that includes a liner and labels detachably attached to the liner.
